(19) United States
(12) Patent Application Publication
(10) Pub. No.: US 2010/0299926 A1
(43) Pub. Date: Dec. 2, 2010

(54) METHOD AND APPARATUS FOR SETTING THE BEARING PLAY OR THE PRESTRESS OF ANTI-FRICTION BEARING ARRANGEMENTS

(75) Inventor: Rupert Stitzinger, Bergrheinfeld (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/739,510

(22) PCT Filed: Oct. 21, 2008
(86) PCT No.: PCT/DE08/01717

§ 371 Date: Apr. 23, 2010

(30) Foreign Application Priority Data
Oct. 26, 2007 (DE) 10 2007 051 237.8

(51) Int. Cl. F16C 43/06; B21D 53/10

(52) U.S. Cl. 29/898.09; 29/724

(57) ABSTRACT

A method and an apparatus for setting bearing play or prestress of anti-friction bearing arrangements with at least two outer or inner rings which are adjustable axially with respect to one another, at least two inner or outer rings fixed axially with respect to one another, and rolling bodies arranged between them. The rolling bodies roll on rolling tracks of the bearing rings and are guided in cages in which markings are arranged on at least one rolling body. A sensor is attached to a cage and an evaluation unit is coupled to the sensor. To set the prestress and bearing play, the bearing arrangement is loaded with an axial force or tilting moment. The bearing arrangement is rotated by at least one full revolution, the rolling-body rotation is recorded by a sensor, and the outer or inner rings are adjusted in relation to the predefined prestress or hearing play.

### FIELD OF THE INVENTION

The invention relates to a method and an apparatus for setting the bearing play or the prestress of anti-friction bearing arrangements having at least two outer or inner rings which can be adjusted axially with respect to one another, at least two inner or outer rings which are fixed axially with respect to one another, and rolling bodies which are arranged between them, roll on rolling tracks of the bearing rings and are guided in cages.

### BACKGROUND OF THE INVENTION

Anti-friction bearing arrangements of this type, in particular if they are tapered roller bearings, are set to the correct play or the correct prestress during assembly. In the case of large tapered roller bearings for, for example, wind energy plants, the setting to the correct play during assembly takes place with setting to stationary points on the superstructure with the aid of given variables, such as the precise dimensions of the bearings, the shaft diameter, the bearing spacing, etc. On account of the chain of errors, this can lead to considerable overall errors in the setting of play or prestress.

In order to avoid this problem and to facilitate the setting of the bearing play or the prestress, it is known from DE 10 2005 055 995 A1 to determine the prestress of a tapered roller bearing pair in such a way that a magnetic coding is applied to at least one of the bearing rings or to a shaft part between the bearing rings, and the change in the magnetic coding on account of the prestress applied is detected by a sensor and taken into account during the setting of the prestress.

A further possibility of setting the bearing play or the bearing prestress during the assembly of bearings which have a conical inner bore and are pressed onto a conical shaft piece is, according to DE 695 14 046 T2, to attach strain gages to the bearing ring which is pressed onto the conical shaft piece and therefore to measure the widening of the bearing ring directly while it is being pressed on. This measured value is then used to determine the pressing travel of the bearing ring which is required to set the predefined bearing play or the predefined prestress.

In addition, DE 601 10 960 T2 has disclosed an apparatus for measuring and setting the prestress in a bearing, in which apparatus a spacer ring is arranged between bearing rings which can be adjusted axially with respect to one another, the axial extent of which spacer ring can be varied by means of piezoelectric or magnetostrictive elements. The prestress can be determined directly from the amounts of electricity which are applied to the piezoelectric elements or magnetostrictive elements.

DE 43 28 081 A1 describes different methods for prestressing anti-friction bearings which are high precision small anti-friction bearings for IT applications. According to said document, the prestress can be determined via the acoustic resonant frequency of a bearing ring which changes as the prestress is applied. The desired prestress has been reached when a reference value is matched. Furthermore, said document describes the direct measurement of the displacement of the bearing ring during the application of the prestress, the displacement travel being proportional to the prestress which is applied. A further described option is to rotate the bearing during the application of the prestress and to analyze the vibrations in the process. Finally, the option is also specified of measuring the torque which is transmitted to a stationary bearing ring during the rotation of the bearing arrangement until a predefined reference value is reached.

All these known methods and apparatuses are complicated in design, not very precise, can be handled only with difficulty and can be automated poorly or not at all.

### OBJECT OF THE INVENTION

Proceeding from the stated disadvantages of the solutions of the known prior art, the invention is therefore based on the object of providing a method and an apparatus for setting the bearing play or the prestress of anti-friction bearing arrangements, which method and apparatus are easy to handle, simple to automate and correspondingly simple in design.

### DESCRIPTION OF THE INVENTION

In accordance with the features of claim 1, this object is achieved by a method for setting the bearing play or the prestress of anti-friction bearing arrangements having at least two outer or inner rings which can be adjusted axially with respect to one another and at least two inner or outer rings which are fixed axially with respect to one another, and rolling bodies which are arranged between them and roll on rolling tracks of the bearing rings, having the following steps:
loading of the anti-friction bearing arrangement which has a bearing play with an axial force or a tilting moment,
rotation of the anti-friction bearing arrangement by at least one full revolution,
detection of the rolling body rotation by means of a sensor, and
adjustment of the outer or inner rings which are adjustable axially with respect to one another by an amount which corresponds to the predefined prestress or the predefined bearing play.

The method according to the invention proceeds from the concept that, when an anti-friction bearing arrangement which has a bearing play is loaded with an axial force or a tilting moment and the anti-friction bearing arrangement is rotated by at least one full revolution, the rolling bodies which move on account of the bearing play at least over part of one revolution without contact with the bearing rings do not rotate about themselves, since they do not roll on the rolling tracks of the bearing rings, with the result that the information about this rotation of the rolling bodies about themselves or their standstill can be used for setting the predefined bearing play or the predefined bearing prestress correctly.

The step of the detection of the rolling body rotation by means of a sensor can preferably take place at least one rolling body which is provided with a marking which can be detected by a rotation sensor, which at least one rolling body, in the case of the loading of the anti-friction bearing arrangement which has a bearing play and in the case of its rotation at least over part of one revolution of the anti-friction bearing arrangement, does not rotate about itself.

In detail, one option to set the bearing play or the prestress comprises, in the case of anti-friction bearing loading by a tilting moment, the step of the detection of the rolling body rotation comprising the recording of that circular angle, over which the at least one rolling body which is provided with a marking rolls and rotates about itself or conversely does not rotate during one full revolution of the anti-friction bearing arrangement, and the magnitude of the adjustment travel of the outer or inner rings which can be adjusted axially with respect to one another, in order to achieve the predefined prestress or the predefined bearing play, being determined from the detected circular angle.

Another option to set the bearing play or the prestress of anti-friction bearing arrangements comprises, during the step of the detection of the rolling body rotation by means of the rotation sensor, the outer or inner rings which can be adjusted axially with respect to one another being moved toward one another until, over one complete revolution of the anti-friction bearing arrangement, at least one rolling body rolls on the rolling tracks of the bearing rings, without sliding, and in the process rotates about itself, and a zero play or a slight prestress is then achieved. This option can be used both in the case of a vertical extent of the axis of the anti-friction bearing arrangement and in the case of a substantially horizontal extent of the same, that is to say in the case of loading with an axial force in the case of the vertical extent of the axis of the anti-friction bearing arrangement and in the case of application of a tilting moment in the case of a substantially horizontal extent of the axis of the anti-friction bearing arrangement.

The object mentioned in the preceding text is also achieved by an apparatus for setting the bearing play or the prestress of anti-friction bearing arrangements having at least two outer or inner rings which can be adjusted axially with respect to one another, at least two inner or outer rings which are fixed axially with respect to one another, and rolling bodies which are arranged between them, roll on rolling tracks of the bearing rings and are guided in cages, which is characterized by markings which are attached to at least one rolling body, a sensor which is attached to a cage and reacts to the markings, and an evaluation unit which is coupled to the sensor.

These markings can be produced by means of eroding, it being possible for the sensor to be configured as a magnetically back-clamped Hall sensor or a magnetostrictive sensor.

If the evaluation unit is configured in such a way that it can use the rolling body rotation to determine the circular angle, over which the at least one rolling body which is provided with markings rolls and rotates about itself or conversely does not rotate about itself during one full revolution of the anti-friction bearing arrangement, the magnitude of the adjustment travel of the outer or inner rings which can be adjusted axially with respect to one another can be determined from this, in order to achieve the predefined prestress or the predefined bearing play. It is then no longer necessary to set the outer or inner rings which are adjustable axially with respect to one another against one another, until all the rolling bodies roll on the rolling tracks of the bearing rings, without sliding, over one complete revolution of the anti-friction bearing arrangement and a zero play or a slight prestress is achieved, in order then to subsequently adjust the outer or inner rings which are adjustable axially with respect to one another, by an amount which corresponds to the predefined prestress or the predefined bearing play.

The setting of the bearing play or the prestress of anti-friction bearing arrangements can be automated simply by way of the apparatus according to the invention, if the evaluation unit is operatively connected to an adjusting apparatus for automatically setting the prestress or the bearing play of the anti-friction bearing arrangement, for example via a control line.

### BRIEF DESCRIPTION OF THE DRAWINGS

In the following text, one preferred embodiment of the anti-friction bearing which is configured according to the invention is explained in greater detail with reference to the appended drawings, in which:

FIG. 1 shows a sectional view of an anti-friction bearing arrangement with tapered roller bearings, which anti-friction bearing arrangement can be used, for example, for a bevel gear mechanism or a wind energy plant; and

FIG. 2 shows a front view of a cone bearing of the anti-friction bearing arrangement according to FIG. 1 with an illustration of markings on a rolling body which are to be recorded by a sensor.

### DETAILED DESCRIPTION OF THE DRAWINGS

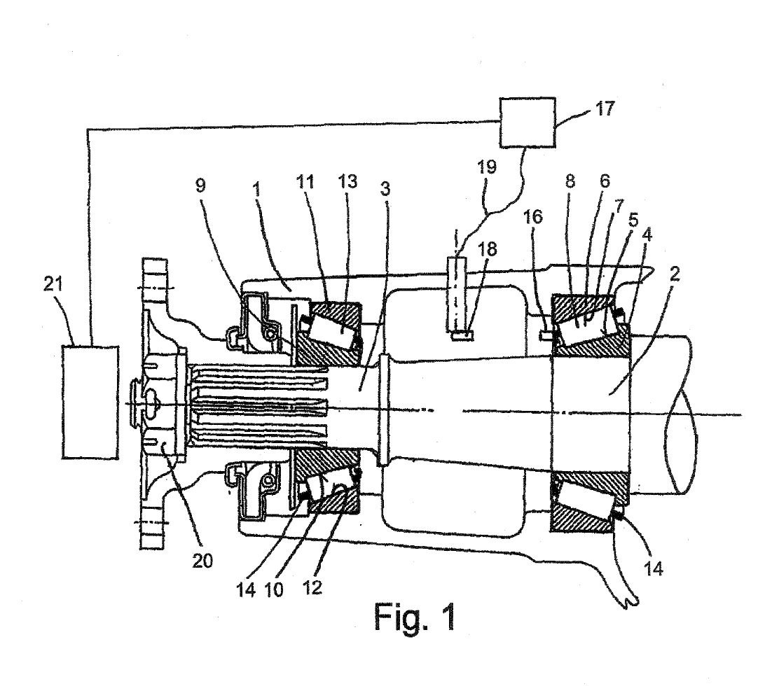

The anti-friction bearing arrangement shown in FIG. 1 shows a shaft which is mounted in a bearing housing 1 and has two cylindrical shaft parts 2, 3. An inner ring 4 of a tapered roller bearing is pushed onto the shaft part 2. The inner ring 4 has a raceway 5 for rolling bodies 8 which are guided in a cage 14 and are configured as tapered rollers in the present exemplary embodiment. The rolling bodies 8 also roll on a raceway 7 of an outer ring 6 which is arranged in the housing 1.

Correspondingly, a further cylindrical shaft part 3 which is spaced apart from the shaft part 2 is intended to receive an inner ring 9 of a further tapered roller bearing. Said inner ring 9 has a raceway 10 for rolling bodies 13 which are guided in the cage 14 and roll, furthermore, on a raceway 12 of an outer ring 11. The outer ring 11 is likewise arranged in the housing 1. The outer rings 6, 11 are fixed in the housing 1 with regard to their axial spacing, whereas the inner ring 9 is displaceable axially on the cylindrical shaft part 3 in the direction of the inner ring 4 by means of a tensioning element 20 which is configured as a shaft nut, in order to set the bearing play or the prestress.

A sensor 16 is attached to one of the bearing cages 14 in the region of a tapered roller 8 which is provided with markings 15, which sensor 16 serves to detect the rotation of the tapered roller 8 with the markings 15 and to transmit wirelessly to a telemetry apparatus 18 which is fixed to the housing. The telemetry apparatus 18 is connected via a cable link 19 to an evaluation unit 17 which for its part is operatively connected to an adjusting apparatus 21 for the tensioning element 20.

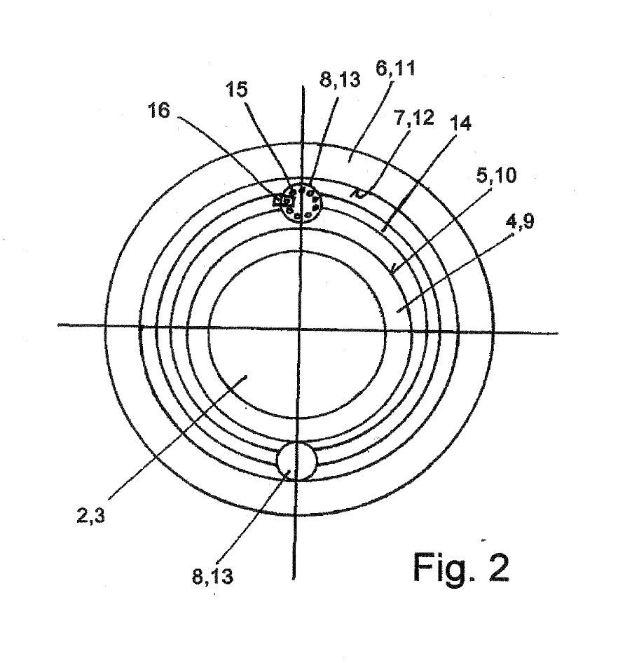

At the beginning of the assembly of this bearing arrangement, the tapered roller bearing 4, 6, 8 has a bearing play which is shown on an exaggerated scale in FIG. 2, in the case of a loading of the shaft 2, 3 with a tilting moment. When this tilting moment is directed in such a way that a force which is directed downward in FIG. 2 acts on the tapered roller bearing 4, 6, 8, the inner ring 4 loads the lower tapered rollers 8 via a circular angle which is dependent on the elasticity of the bearing arrangement, whereas the upper tapered rollers 8 do not make contact with the inner ring 4 and the outer ring 6. The tapered rollers 8 which do not make contact with the inner ring 4 and the outer ring 6 likewise extend over a defined circular angle. When the shaft 2, 3 is rotated, the tapered rollers 8 which are in contact with the inner ring 4 and the outer ring 6 roll on the rolling tracks 5, 7 and rotate about their rotational axis, whereas the tapered rollers 8, which are not in contact with the rolling tracks 5, 7, are stationary. This rotation of the tapered rollers 8 can be detected by means of the sensor 16 which is situated on the cage 14 opposite at least one tapered roller 8, to which the markings 15 are attached. During the rotation of the shaft 2, 3, the signals of the sensor 16 are transmitted to the telemetry apparatus 18 and via the cable 19 to the evaluation unit 17.

This evaluation unit 17 can determine the existing bearing play from the circular angle, over which the tapered rollers 8 rotate or do not rotate, can compare it with a predefined value and can determine the required axial adjustment of the inner ring 9 of the tapered roller bearing 9, 11, 13 from this. This adjustment travel can then be set automatically by means of the adjusting apparatus 21 which acts on the tensioning element 20, and the predefined bearing play or the bearing prestress is achieved.

Another option for setting the bearing play or the bearing prestress is to rotate the shaft 2, 3 under an axial loading or under loading with a tilting moment, detecting the rotation of the rolling body 8 which is provided with the markings 15, and adjusting the inner ring 9 by means of the adjusting apparatus 21 until the rolling body 8 which is provided with the markings 15 rotates about itself over one complete revolution of the shaft 2, 3. At this point, the zero play or a slight prestress is achieved. Proceeding from this, the inner ring 9 is then adjusted by a predefined amount by means of the adjusting apparatus 21, in order to set a predefined bearing play or a predefined bearing prestress.

When the shaft 2, 3 is loaded with a tilting moment, the tapered rollers 8 rotate only over a defined circular angle range, as long as there is still bearing play. When the shaft 2, 3 is loaded with an axial force, all the rolling bodies 8, 13 which are loaded with the axial force rotate continuously, whereas the tapered rollers 8, 13 which are then unloaded do not complete any revolution at all about their own rotational axis. In this case, the corresponding inner ring 4, 9 is adjusted axially until all the tapered rollers 8, 13 rotate over one complete revolution, and the bearing play or the bearing prestress is then set in the way which has already been described.

The method according to the invention and the apparatus can be used not only in tapered roller bearings, but can also be used analogously in angular contact ball bearings or deep groove ball bearings which can be set with respect to one another.

### LIST OF DESIGNATIONS

1 Bearing housing
2 Cylindrical shaft part
3 Cylindrical shaft part
4 Inner ring
5 Raceway
6 Outer ring
7 Raceway
8 Rolling body
9 Inner ring
10 Raceway
11 Outer ring
12 Raceway
13 Rolling body
14 Cage
15 Markings
16 Sensor
17 Evaluation unit
18 Telemetry apparatus
19 Cable link
20 Tensioning element
21 Adjusting apparatus

1. A method for setting bearing play or prestress of anti-friction bearing arrangements having at least two outer or inner rings which are adjustable axially with respect to one another and at least two inner or outer rings which are fixed axially with respect to one another, and rolling bodies which are arranged between them and roll on rolling tracks of the bearing rings, the method comprising the following steps:
loading the anti-friction bearing arrangement, which has a bearing play, with an axial force or a tilting moment;
rotating the anti-friction bearing arrangement by at least one full revolution;
detecting the rolling body rotation by means of a sensor; and
adjusting the outer or inner rings which are adjustable axially with respect to one another by an amount which corresponds to a predefined prestress or a predefined bearing play.

2. The method of claim 1, wherein the step of detecting the rolling body rotation by means of a sensor takes place at least one rolling body which is provided with a marking that is detectable by a rotation sensor, which at least one rolling body in a case of the loading of the anti-friction bearing arrangement which has a bearing play and in the case of its rotation, does not roll and does not rotate about itself at least over part of one revolution of the anti-friction bearing arrangement.

3. The method of claim 2, wherein, in the case of anti-friction hearing loading by the tilting moment, the step of detecting the rolling body rotation comprises recording of that circular angle, over which the at least one rolling body which is provided with a marking rolls and rotates about itself or does not roll and does not rotate about itself during one full revolution of the anti-friction bearing arrangement, and in that the magnitude of the adjustment travel of the outer or inner rings which are adjustable axially with respect to one another, in order to achieve the predefined prestress or the predefined bearing play, is determined from the detected circular angle.

4. The method of claim 2, wherein, during the step of detecting the rolling body rotation by means of the rotation sensor, the outer or inner rings which are adjustable axially with respect to one another are moved toward one another until, over one complete revolution of the anti-friction bearing arrangement, at least one rolling body rolls on the rolling tracks of the hearing rings, without sliding, and in the process rotates about itself, and a zero play or a slight prestress is then achieved.

5. An apparatus for setting bearing play or prestress of anti-friction bearing arrangements, comprising:
at least two outer or inner rings which can be adjusted axially with respect to one another;
at least two inner or outer rings which are fixed axially with respect to one another; and
rolling bodies which are arranged between the outer and inner ring, roll on rolling tracks of the outer and inner rings and are guided in cages,
wherein markings are attached to at least one rolling body, a sensor is attached to a cage and reacts to the markings, and an evaluation unit is coupled to the sensor.

6. The apparatus of claim 5, wherein the markings are produced by means of eroding and the sensor is configured as a magnetically back-clamped Hall sensor or a magnetostrictive sensor.

7. The apparatus of claim 5, wherein the evaluation unit can use the rolling body rotation to determine circular angle, over which the at least one rolling body which has the markings rolls and rotates about itself or does not roll and does not rotate about itself during one full revolution of the anti-friction bearing arrangement, and can determine from this the magnitude of the adjustment travel of the outer or inner rings which are adjustable axially with respect to one another, in order to achieve the predefined prestress or the predefined bearing play.

8. The apparatus of claim 5, wherein the evaluation unit detects the rolling body rotation of the at least one rolling body which has the marking over one full revolution of the anti-friction bearing arrangement, and determines from this the magnitude of the adjustment travel of the outer or inner rings which are adjustable axially with respect to one another, in order to achieve the predefined prestress or the predefined bearing play.

9. The apparatus of claim 7, wherein the evaluation unit is operatively connected to an adjusting apparatus for automatically setting the prestress or the bearing play of the anti-friction bearing arrangements.

10. The apparatus of claim 8, wherein the evaluation unit is operatively connected to an adjusting apparatus for automatically setting the prestress or the bearing play of the anti-friction bearing arrangements.
